(19) United States
(12) Patent Application Publication
(10) Pub. No.: US 2011/0040693 A1
(43) Pub. Date: Feb. 17, 2011

(54) WEBSITE INCLUDING BID FILTERING

(75) Inventor: Qiang Du, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qiang Du, Mountain View, CA (US)

(21) Appl. No.: 12/851,327

(22) Filed: Aug. 5, 2010

Related U.S. Application Data
(60) Provisional application No. 61/233,385, filed on Aug. 12, 2009.

(51) Int. Cl. G06Q 99/00; G06Q 30/00

(52) U.S. Cl. 705/319

(57) ABSTRACT

Systems and methods for improving social networking websites, such as dating websites, are disclosed. An owner of the website can capitalize on the quality of the user base. A bidding process can be used to limit access to highly desirable users. In some cases revenue generated from the bidding process will belong to the website owner, while in other cases, the revenues may be shared with the highly desirable users. Revenue need not be entirely financial, as the bidding process may operate with anything of value.

### CROSS-REFERENCES TO RELATED APPLICATIONS

This application claims the benefit of and priority to U.S. Provisional Patent Application No. 61/233,385, entitled “WEBSITE INCLUDING BID FILTERING” filed Aug. 12, 2009, the entire contents of which are incorporated herein by reference for all purposes.

### BACKGROUND

The internet contains large numbers of social networking websites. Some of these websites are used to maintain contact with people that users already know. Other social networking websites are directed toward maintaining business relationships. Some social networking websites are directed toward establishing new relationships with persons who are not yet known to the user. This third type of social networking website can be generically referred to as a dating website. Although the present disclosure will be described in terms of a dating website, the concepts described herein are applicable to any type of social networking site.

Dating websites typically serve the purpose of matching persons previously unknown to each other for purposes of establishing relationships. The goals of the relationships can vary greatly. Some websites may be directed to allowing users to establish casual, online only relationships, while other websites may be geared toward helping users find potential mates for purposes of marriage. Websites for establishing relationships anywhere along this spectrum are also are available. Embodiments of the disclosure are applicable to any form of social networking site where users attempt to initiate contact with each other.

Dating websites need to maintain a pool of users. From this pool, users may review profile information of other users to make selections of users to with whom to initiate contact. The pool of users, like any other general population, will contain some users who are below average, a majority who are average, and some users who stand out from the crowd. An owner of a dating website would seek to maximize the number of outstanding users in order to attract the largest number of overall users to the website. For example, if the majority of a community of users of a dating website are below average in attractiveness, users may stay away from that particular dating website because the chances of finding a relationship partner of acceptable attractiveness may be diminished. The same is true of any other characteristic, such as education, net worth, or any number of other characteristics that make a person desirable from a relationship perspective.

The owner of the website would like to retain or increase the number of outstanding users who frequent the dating website. Furthermore, the owner of the website would desire to capitalize on the presence of the outstanding users on the dating website.

Embodiments of this disclosure address these and other problems individually and collectively.

### SUMMARY OF THE INVENTION

Systems and methods for improving social networking websites, such as dating websites, are disclosed. An owner of the website can capitalize on the quality of the user base. A bidding process can be used to limit access to highly desirable users. In some cases revenue generated from the bidding process will belong to the website owner, while in other cases, the revenues may be shared with the highly desirable users. Revenue need not be entirely financial, as the bidding process may operate with anything of value.

One embodiment of the present disclosure is directed to a method of restricting access to a user of a social networking website. The method comprises identifying the user of the social networking website as an outstanding user; initiating, with a server computer, a bidding process for the opportunity to contact the outstanding user; and allowing contact with the outstanding user by a high bidder in the bidding process.

In one embodiment, the bidding process is conducted periodically. In one aspect of this embodiment, the period is one of hourly, daily, and weekly. In one embodiment, the owner of the social networking website identifies the outstanding user. In another embodiment, users self identify as outstanding users.

In one aspect, the opportunity to contact the outstanding user includes the opportunity to send an e-mail to the outstanding user. In another aspect, contact is limited to the top five bidders in the bidding process.

In one embodiment, the bids in the bidding process comprise monetary value, and the proceeds of the bids are provided to the owner of the social networking website. In another embodiment, the bids in the bidding process comprise monetary value, and the proceeds are distributed between the owner of the social networking website and the outstanding user. In one aspect, the bids in the bidding process comprise credits on the social networking website. In a further aspect, the credits are earned based on interactions with the social networking website.

In one embodiment, the method further comprises reviewing all users of the social networking website to identify outstanding users. In one aspect, outstanding users are identified based on a number of contact requests. In a further aspect, once the high bidder is allowed contact with the outstanding user, the high bidder is no longer restricted from contacting the outstanding user.

Systems and non-transitory computer readable medium embodying the invention are also disclosed.

### BRIEF DESCRIPTION OF THE DRAWINGS

FIG. 1 depicts a block diagram of a dating website system.

FIG. 2 depicts an exemplary screenshot of a users statistics page.

FIGS. 3(a-b) depict selection of a user for the bid filtering process.

FIG. 4 depicts browsing user profiles.

FIGS. 5(a-c) depict screenshots of a bidding process, and the results.

FIGS. 6(a-b) depict screenshots of discontinuing the bid filtering process.

FIG. 7 depicts a high level flow chart of the bid filtering process.

FIG. 8 shows a block diagram of a computing system.

### DETAILED DESCRIPTION

In the following description, for the purposes of explanation, specific details are set forth in order to provide a thorough understanding of embodiments of the disclosure. However, it will be apparent that embodiments of the disclosure may be practiced without these specific details.

Embodiments of the present disclosure provide systems and methods for providing a bidding system for users of social networking sites, such as dating websites. Dating websites will typically have a population of users who are seeking each other out for purposes of companionship, friendship, romance, marriage, or any number of other reasons. As with any population of people, some people will stand out from the crowd. For the remainder of the disclosure, these highly desirable users will be referred to as outstanding users. Outstanding users may have characteristics that make them highly desirable to the community of users of the dating website.

For example, the outstanding users may have above average physical attractiveness, above average net worth, above average intelligence, or any other characteristic that would make the outstanding user highly desirable. Common wisdom would indicate that being an outstanding user would be a desirable trait from the point of view of the outstanding user. However, this may not always be the case. Because of the characteristics possessed by the outstanding users, it is possible that many members, perhaps too many members, of the dating website will wish to initiate contact with the outstanding users.

In some embodiments, the users of the dating website may initiate contact with other users through the use of an e-mail. Other mechanisms of initiating contact can include Instant Messaging, SMS Text Message, phone calls, or any other suitable communications facilities. For ease of description, the remainder of the disclosure will describe the system in terms of e-mail as the mechanism for initiating contact. However, it should be understood that embodiments of the invention are not limited to e-mail communication only. Any suitable communications mechanism has been contemplated.

For the outstanding users, the number of incoming contact requests, such as incoming e-mail messages, may become overwhelming. Potentially compounding the problem may be the fact that many users attempting to initiate contact are not of the same caliber as the outstanding user and would not be they type of person with whom the outstanding user wishes to establish a relationship. An outstanding user may become frustrated with the volume of incoming contact requests and having to filter through all of the unworthy requests. In a worst case scenario, the problems may lead the outstanding user to quit the dating site completely, depriving the outstanding user of the opportunity to engage in a satisfying relationship.

Outstanding users who do quit the dating website pose an even bigger problem to the website owner. If the most desirable users of the dating website become frustrated and quit the website due to the overwhelming number of contact requests, the website owner is left with users who are much less desirable. A dating website that is void of outstanding users may have trouble attracting additional users. If profiles of all the remaining users are somewhat unimpressive, a new user would have little incentive to join the dating website. Furthermore, the website owner may lose out on the potential to capitalize on the desirability of the outstanding users.

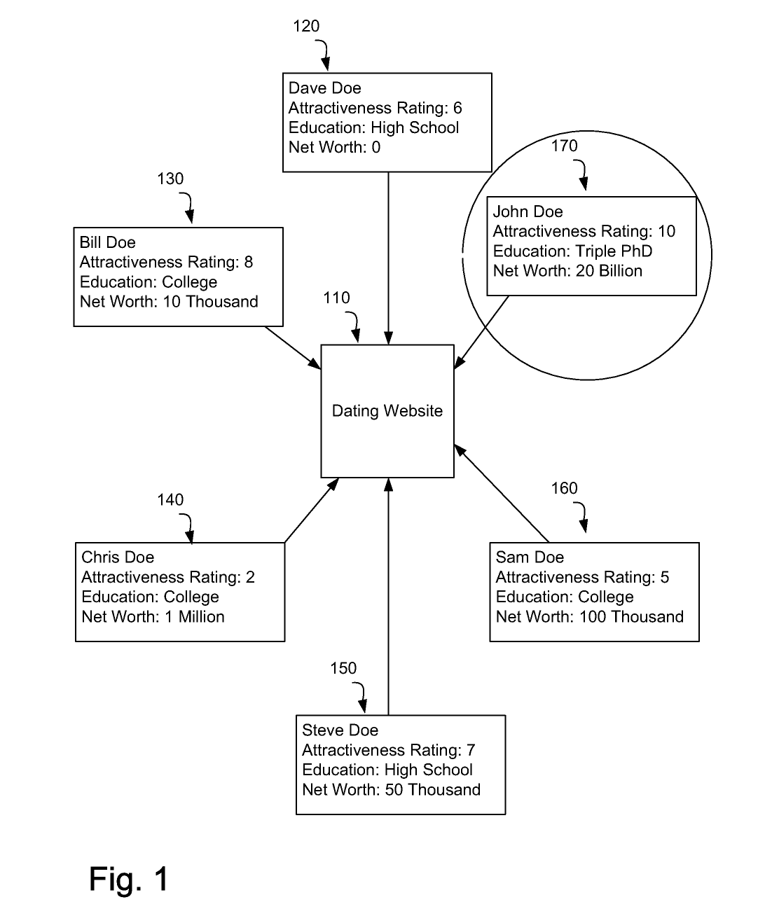

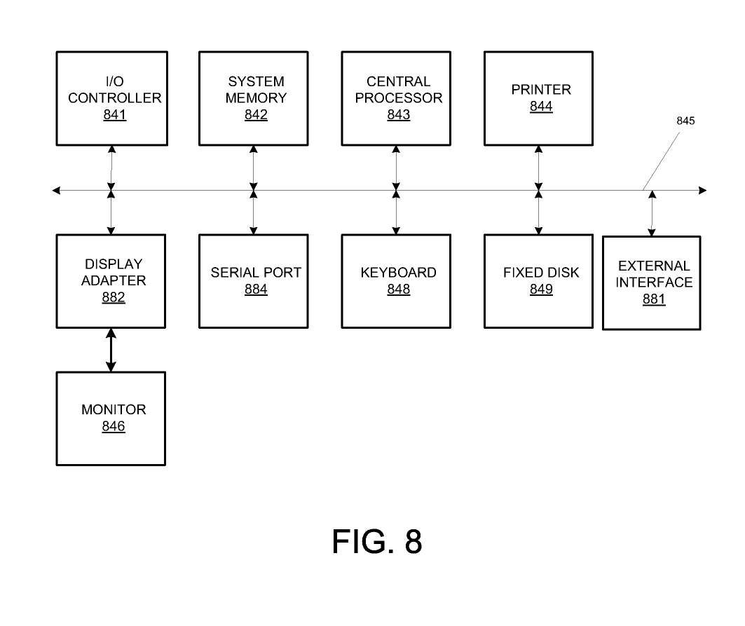

FIG. 1 depicts a block diagram of a dating website 110. The website may be hosted on a computing system as described in FIG. 8. The dating website 110 may provide facilities for users of the website to input information about themselves. For example, user profiles 120, 130, 140, 150, 160, and 170 may contain information about each user. For purposes of explanation, the profiles depicted in FIG. 1 are very simplistic, containing only rudimentary information, such as a user's level of education, and current net worth. The user's profile may also contain information about the user's physical attractiveness.

On some dating websites, certain characteristics of the user may not be specified by the user himself, but rather are based on the collective wisdom of the entire community of users of the dating website. One characteristic that lends itself to this technique is the physical attractiveness rating. People tend to either over or under estimate their own physical attractiveness, and a self rating may be inaccurate. Some dating websites may allow the community of users to rate an individual user's attractiveness based on a photograph, or some other technique.

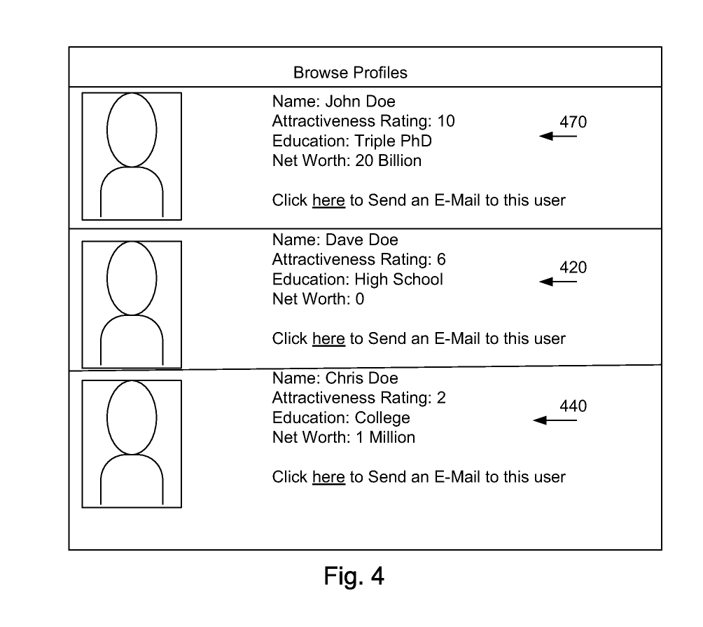

Some dating websites allow users to review each other's profile information, and based on actual or perceived similarities in profiles, allow the users to initiate contact with other users. In some cases, the dating website may allow a prospective suitor to specify desired criteria for a relationship partner, and the dating website will provide lists of users who match the criteria. In yet other cases, the dating website itself may select users who are felt to be a good match by the dating website. This will be described in further detail with respect to FIG. 4.

Some users' profiles may contain highly desirable characteristics that are sought after by large numbers of users of the dating website. For example, users with high physical attractiveness ratings will likely be in greater demand than those with lower ratings. Similar situations can arise from any number of other characteristics, such as level of education, or total net worth. In reviewing the profiles depicted in FIG. 1, it can be seen that the profile of John Doe 170 contains characteristics that would typically be more desirable than the other profiles. As shown in FIG. 1, John Doe 170 has a very high physical attractiveness rating, a very high education level, and a very high net worth. Any one of these characteristics individually may make John Doe 170 highly desirable to the members of the dating website. For purposes of the remainder of the disclosure, users whose profiles stand out, regardless of the particular reason for standing out, will be referred to as outstanding users or outstanding members.

As should seem intuitive, because of the highly desirable characteristics of John Doe 170, it is likely that many users of the dating website would wish to initiate contact with him. As mentioned above, this can cause frustration on the part of John Doe, as his e-mail inbox may become flooded with requests for contact. The process of filtering all of these requests manually may cause John Doe 170 to become fed up with the dating website, and quit.

Embodiments of the present disclosure provide for a bidding system in which the opportunity to initiate contact with outstanding members, such as John Doe 170, may be provided to only the highest bidders. By limiting the ability to initiate contact with the outstanding users, the level of frustration experienced by the outstanding users may be decreased. Furthermore, the website owner may capitalize on the presence of the outstanding users on the website in order to increase revenue, traffic, or any other goal as defined by the website owner.

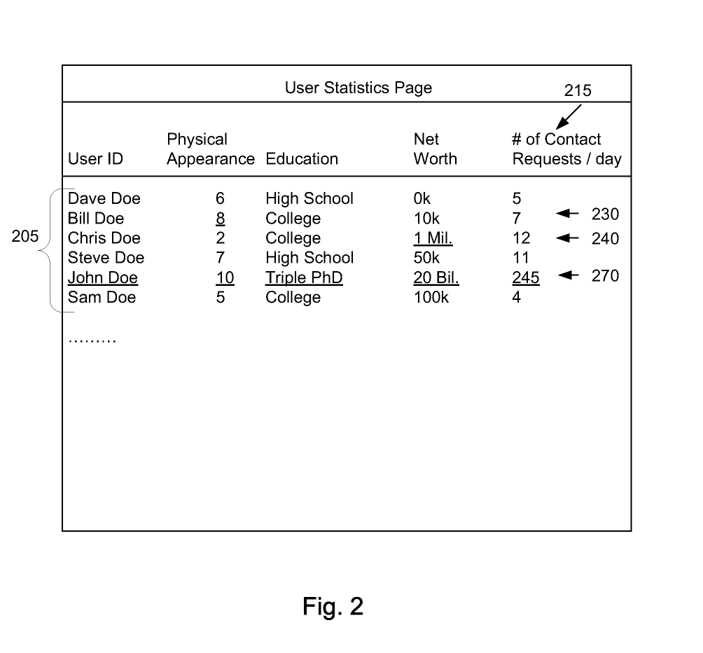

FIG. 2 depicts an exemplary screen shot wherein the website owner may select outstanding users to engage in the bid filtering process. The first part of the bid filtering process may be to select users that are outstanding. In some embodiments, this process is conducted by the website owner. The owner of the website will typically have access to all of the users' profile information. Furthermore, the website owner may also have data related to how many times other users are attempting to initiate contact with the outstanding user.

As can be seen in FIG. 2, the relevant data 205 for each user of the dating website may be displayed for the website owner. Although only six users are depicted in FIG. 2, it should be understood that this is for the purposes of simplicity of explanation. In an actual operating dating website, there may be hundreds, thousands, or hundreds of thousands of users. Although it would be possible for the website owner to manually review the profile of each user to determine if they are outstanding, this may not be the most efficient manner of completing the identification process.

In some embodiments, the website owner may set criteria that he feels define an outstanding user. The dating website itself may them programmatically review the profiles of each user to determine if they qualify as an outstanding user. For example, the website owner may specify that users with a physical attractiveness rating of greater than eight are considered outstanding users. As is shown in FIG. 2, users Bill 230 and John 270 meet the criteria of having an attractiveness rating greater than eight. Similarly, such a criteria can be set by the website owner for the category of net worth. In FIG. 2, the website owner may have designated users with a net worth of one million dollars or more will be designated as outstanding users. In the example of FIG. 2, users Chris 240 and John 270 satisfy this criteria. As yet another example, the website owner may specify that an education above a college degree will qualify a user as an outstanding user. Here, of the users depicted, only John 270 satisfies the criteria.

The website owner may specify that users who meet the criteria for being designated outstanding for a single category will automatically be classified as outstanding users. The website owner may also specify other numbers of criteria, such as two, three, four, or all categories before a user is considered outstanding. In some embodiments, the website owner may programmatically review the user base to identify potential outstanding users as described above, and the website owner will manually make the final decision as to which of the identified users will be designated outstanding.

In one embodiment, the website owner will have access to the number of contact requests received by each user. As depicted in FIG. 2, there is a column 280 which lists the number of incoming contact requests received each day by each user. Although the number of contact requests per day is shown in FIG. 2, it should be understood that any other level of granularity, such as contact requests per hour, per week, per month, or any other period have also been contemplated.

Although all of the categories described above may provide an indication as to which users are the outstanding users, the number of contact requests may be the best indicator of the desires of the community of users of the dating website. If there are large numbers of contact requests for a given user, it is likely that that user has qualities that are highly sought after by the community of dating website users. It may not be possible to quantify exactly what makes the outstanding user outstanding. A large volume of contact requests would indicate that there is something that makes the user highly desirable, even if exactly what that something is cannot be identified.

In any case, a large number of contact requests for a user is at minimum a clear indication that there is demand for that user's attention. Embodiments of the present invention advantageously make use of the demonstrated demand to enhance the website owners revenue stream by allowing the website owner to capitalize on the demand.

After reviewing the user statistics page as depicted in FIG. 2, the web site owner may select users that are determined to be outstanding. As mentioned above, this may be done manually, or automatically by a computer program. However, in any case, the outstanding users are identified. In the present example, user John Doe 270 will be selected as an outstanding user, and the remainder of the disclosure will be described in terms of John Doe 270 having been selected as an outstanding user. It should be understood that the selection of a single user is for purposes of simplicity of explanation, and is not intended to be limiting. Any number of users can also be designated as outstanding users, up to and including the designation of all users as outstanding users.

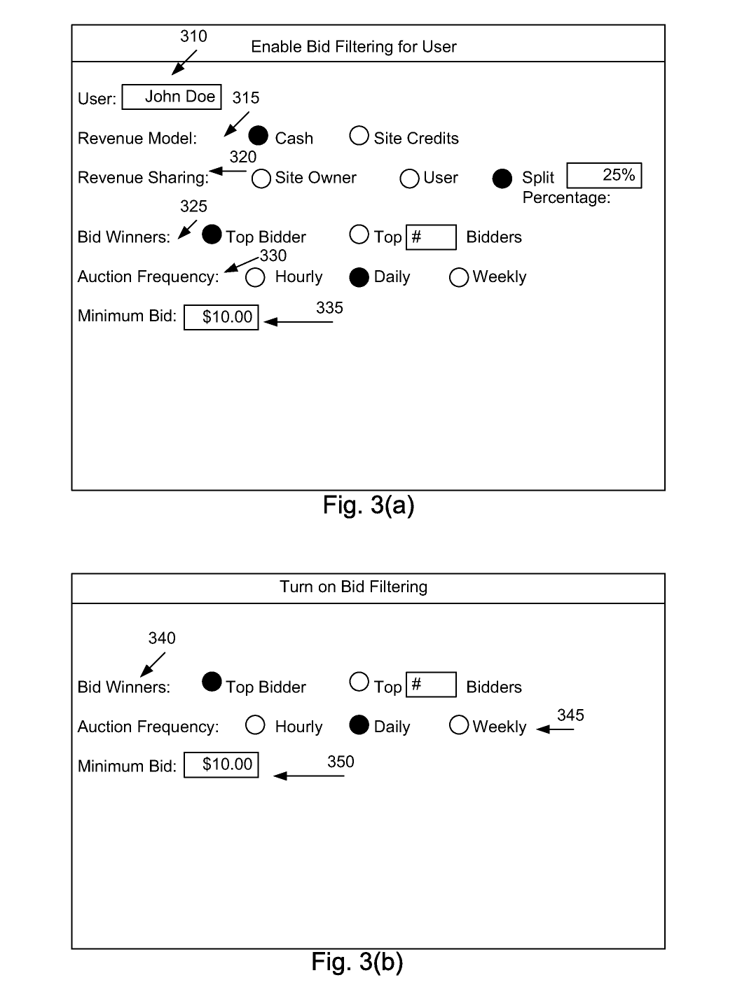

FIG. 3(a) depicts a screenshot of the selection of an outstanding user to initiate the bid filtering process. The website owner may select a user to be designated as an outstanding user. In FIG. 3, a user field 310 may be provided, wherein the website owner may enter the name of a user to be designated as an outstanding user. Although FIG. 3 depicts the selection of a user as entry into a text box, it should be understood that this is for purposes of simplicity of explanation only. In some embodiments, the selections may be made from a drop down menu, a list of all users with links to add the user to group of outstanding users, check boxes, or any number of other methods for selection of an item from a list.

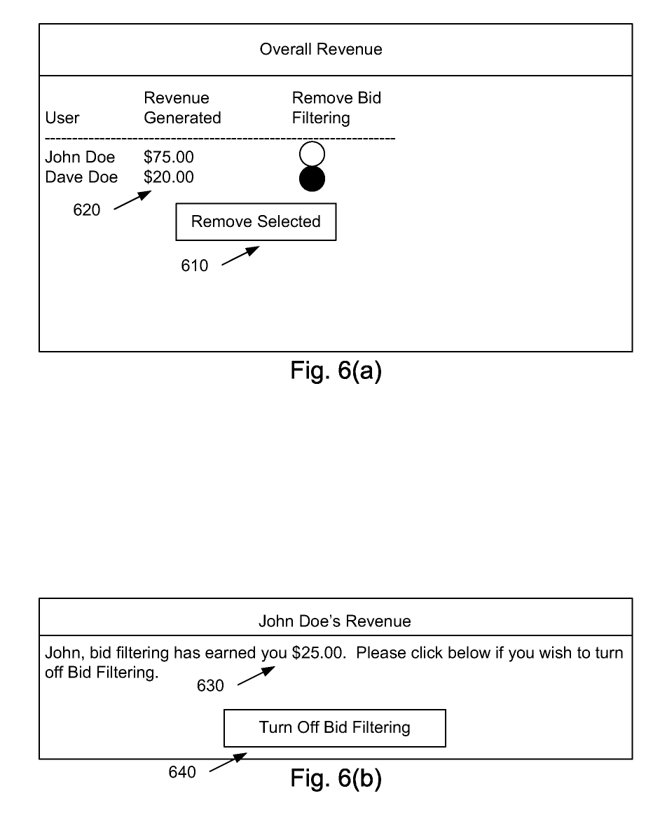

The website owner may then select a revenue model 315 for the bid filtering process for this individual outstanding user. In order for the bidding process to work effectively, users must bid something of value. In a typical scenario, the bids will be financial. In essence, the users who are willing to pay the most money for the opportunity to initiate contact with the outstanding user will be allowed to do so, and those unwilling to spend enough money to win the bidding process will not be allowed to contact the outstanding user. This is the simplest form of revenue generation for the site owner, and can be directly tracked, as will be described with reference to FIG. 6.

In an alternate embodiment, rather than using money directly to bid, the users may purchase “credits” on the dating website, which will then be used to bid. The use of credits, which are only usable on a specific dating website, will be useful in maintaining the users' loyalty to the specific website. If the credits are unusable elsewhere, the user will have an incentive to continue using the specific website, as obtaining a refund for purchased credits may require more effort than the user is willing to expend.

In yet another embodiment, credits may not be purchased, but rather may be earned. For example, a dating website whose primary source of revenue is advertisement views may award credits based on the amount of time spent on the dating website viewing advertisements. As users spend time on the website viewing ads in order to increase their number of site credits available to bid, the web site owner is generating revenue from advertisers based on advertisement views.

If the dating website generates revenue based on users actually clicking on the advertisements, additional credits may be provided for each advertisement the user clicks on and views. Again, the user is benefited by staying on the site and clicking on ads, as this will increase the number of credits he has available to bid. This also allows the website owner to generate revenue, as he is getting paid for each ad clicked on by the users of the dating website.

Once the revenue model 315 has been determined, the website owner may select if revenue sharing 320 will be enabled. In one embodiment, all revenue generated from a cash bidding process will be provided to the website owner. In the case of website credits that are purchased, the website owner generates revenue from the purchase of the credits. Once a user has bid those credits, and wins the bid, the credits may simply be deleted from the bidding user's account.

In another embodiment, revenue sharing may be selected such that the revenue from the bidding process is given to the outstanding user that is being bid on. In the case of a cash model, the revenue may simply be credited to the outstanding user's account, while in the case of a web site credit model, the credits may be placed in the outstanding user's account. The outstanding user may then use these credits to perform his own bidding on the right to contact other users who are designated as outstanding users.

Such an embodiment may be useful for a dating website that generates revenue based on web traffic alone, such as by ad views. The outstanding users may join the website to make money from the bidding process, while the dating website owner profits from the increased web traffic of users who wish to make contact with the outstanding user and thus need to earn credits by viewing/clicking on ads.

In a hybrid approach, the revenue may be shared between the website owner and the outstanding user. For example, a percentage of the revenue may be credited to the website owner, and the remaining percentage given to the outstanding user. The percentage may be selected by the website owner such that any distribution if possible. For example, the split may be 10/90, 25/75, 50/50, 75/25, or 90/10, with the first number being the percentage allocated to the website owner, and the second number being the percentage allocated to the outstanding user.

Sharing revenue with the outstanding user may provide several advantages. The revenue received by the outstanding user provides an incentive for the outstanding user to continue using the dating website. Additionally, sharing of the revenue may entice other outstanding people, who are not already users of the dating website, to become users, in order to make money. Furthermore, as the number of outstanding users on the dating website grows, even more non-outstanding users may be driven to the dating website in order to have the opportunity to contact an outstanding user.

In order to initiate contact with an outstanding member, a user would need to place a bid in an auction style format, for the opportunity to initiate contact. The website owner may select 325 who is allowed to contact the outstanding user by determining who has won the bidding process. In some embodiments, only the top bidder will be allowed to initiate contact, while in other embodiments, initiating contact may be limited to a fixed number of top bidders. For example, in some embodiments, the top three, five, ten, or twelve, or thirteen bidders will be allowed to initiate contact.

By allowing the website owner to designate how many bid winners will be allowed to initiate contact, the website owner advantageously can manage the expectations of the users of the dating website. If only the top bidder is allowed to initiate contact, the losing bidders may become frustrated that they are not being given the opportunity to contact outstanding users. This frustration may cause those users to quit the dating website. However, if several bid winners are selected, the level of frustration may decrease, as there is a greater chance for each user to be one of several top bidders.

If the opposite situation occurs, and too many bidders are allowed to initiate contact, the outstanding user may become frustrated, as he may be receiving too many incoming requests for contact. Thus, the website owner can modify the determination of winning bidders based on the particular preferences of the community of users of the dating website. There is an additional feature that will be described in FIG. 3(b) to allow the outstanding user himself to control the number of winning bidders.

The bidding process may occur periodically 330, such as on an hourly, daily, or weekly schedule. Thus users who do not win the opportunity to initiate contact with the outstanding user may try again at a later time. In some embodiments, the bidding process will only be conducted for the initial contact to the outstanding user. For example, once a user has won the opportunity to initiate contact, subsequent contacts will not require reengaging in the bidding process (although subsequent contact is still dependent on the willingness of the outstanding user to engage in further contact). In other embodiments, users may be required to bid for the opportunity to contact the outstanding user for all contacts, not just the initial contact.

The website owner may also specify a minimum bid 335 that will be allowed. By doing so, the website owner advantageously can ensure a revenue level that is desired. If the minimum bid is set too high, there will likely be no bids for initiating contact with the outstanding user. However, if the bid is set too low, there may be too many bidders. Allowing the website owner to set the minimum bid amount ensures that if there are any bidders, at least a minimum level of revenue will be generated.

Although FIG. 3(a) has been described in terms of enabling bid filtering for a single user, it should be understood that bid filtering can be enabled for as many or as few users as desired by the website owner. For each user that has bid filtering enabled, separate parameters may be specified. For example, for one outstanding user, revenue may be designated to go to the website owner only, while for a different outstanding user, the revenue may be split between the website owner and the outstanding user.

FIG. 3(a) has been described in terms of the website owner enabling bid filtering for outstanding users. However, embodiments of the invention are not limited to selection of outstanding users by the website owner only. As mentioned above, embodiments of the invention also advantageously allow for an outstanding user to limit the number of incoming contact requests, so that the outstanding user is not overwhelmed by contact requests.

FIG. 3(b) depicts a screenshot of a page that allows a user to designate himself as being outstanding, and thus subject to the bidding process. For example, a user who feels he is receiving too many incoming contact requests can turn on bid filtering for himself. The user is able to select some of the same parameters as described above. For example, the user can specify how the winning bidder 340 is determined. If the user wishes to limit contact requests to a single contact per bidding cycle, he can simply specify that only the top bidder will be allowed to make contact.

Similarly, the user can limit the number of incoming contact requests to a specified number by designating the number of top bidders that will be allowed to initiate contact. The user may also be able to specify how often 345 the bidding process will be conducted. In addition, the user may be able to select 350 the minimum bid amount that will be acceptable for a winning bid.

By allowing a user to turn on bid filtering himself, embodiments of the invention advantageously allow for the user to have control over some aspects of how many users are allowed to initiate contact with him. Furthermore, by allowing the user to specify the minimum bid amount, the user is advantageously able to limit contact requests to those users who are serious about initiating contact. For example, if the minimum bid is set high enough, it is likely that only users who have a genuine interest in the person being bid upon will be willing to bid an amount that meets the minimum bid requirement.

In addition to the financial benefits presented above, embodiments of the present disclosure advantageously allow for the dating website to more effectively meet the needs of the outstanding members. By limiting initial contact to an outstanding user to a small number of winners of the bidding process, the outstanding user may be better able to focus their attention on the bid winners. It may be easier for an outstanding member to develop deeper relationships with the smaller set of bid winners, rather than having to divide their attention amongst vast numbers of unfiltered users. The establishment of a deep relationship may allow for an outstanding user to make better choices regarding whom they wish to date, or possibly even marry. Furthermore, the outstanding users are able to know that the bid winners are actually serious about engaging in a relationship, as the bid winners had to part with something of value in order to be given the opportunity to contact the outstanding user.

FIG. 4 depicts browsing user profiles. On some dating websites, a user is able to browse the profiles of other members of the dating website. For example, the user may be able to view a photograph of the other users. In some cases, the profile information may be more detailed, including things such as attractiveness ratings, net worth, or education.

On some dating websites, the user is able to enter search criteria for the profiles of other users. For example, the user can search for other users with a net worth over a certain amount or who have greater than a certain level of education.

On yet other dating websites, the website itself may attempt to match the user with other users based on any number of factors. In essence, the website makes a determination of which users the website thinks will make good relationship partners for each other.

On some websites, a combination of all of these techniques may be utilized. FIG. 4 depicts an exemplary display of profiles that the user may be interested in. How this list of profiles is generated is relatively unimportant. For each profile 420, 440, 470 being browsed, the user may be given the opportunity to initiate contact with that user. For example, as depicted in FIG. 4, each profile may be associated with a link that allows the user to send an e-mail to the person associated with the displayed profile. It should be understood that the selection of an e-mail link is merely exemplary, and that any form of initiating communication could be utilized.

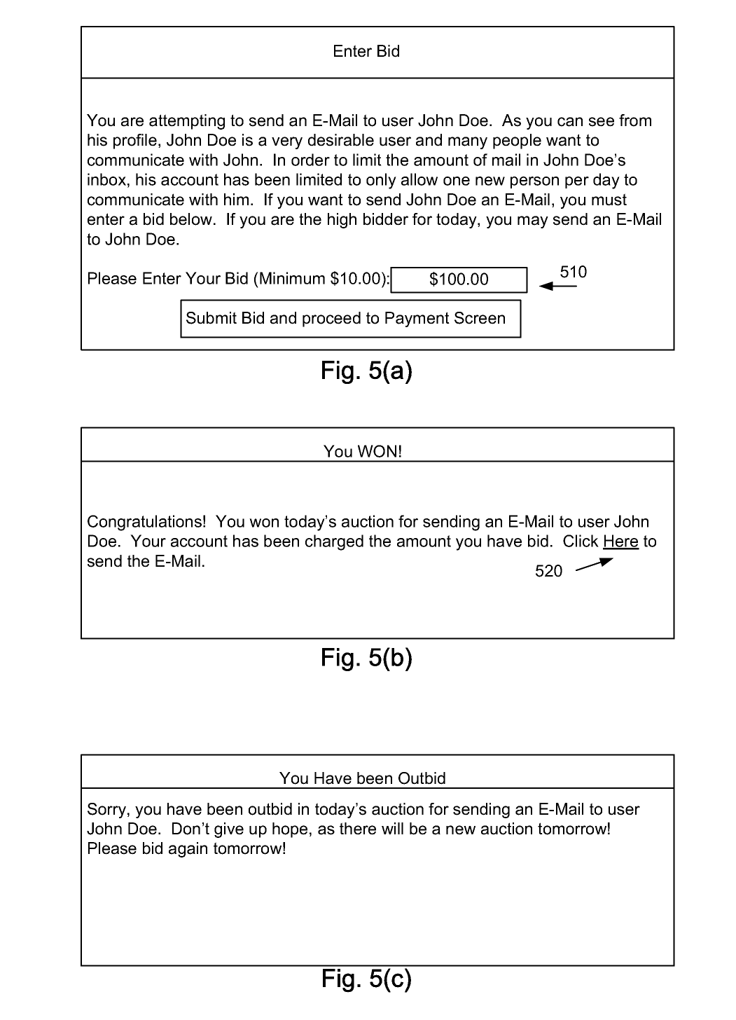

FIG. 5(a) depicts a user who has selected a link to send an e-mail, as described in FIG. 4. However, in the screenshot depicted in FIG. 5(a), the user has selected to initiate contact with a user who has been designated an outstanding user. As shown in the screenshot depicted in FIG. 5(a), the user is attempting to initiate contact with outstanding user John Doe. The user may be provided with a brief explanation of the bidding process. For example, the user may be informed the user John Doe is an outstanding user, and that his account is limited to only one new contact request per day. As explained with reference to FIG. 3, the limits of the number of new contacts per day are selectable by either the web site owner or the outstanding user himself.

The user may further be informed that if he wishes to attempt to contact the outstanding user, he must bid on the opportunity to do so. The user may be presented with a location 510 in which to enter the amount he wishes to bid to try and win the opportunity to initiate contact with the outstanding user. The user may also be notified of any minimum bid amount. Again, as described in FIG. 3, the amount of a minimum bid may be set by the website owner or the outstanding user himself.

FIG. 5(b) depicts an exemplary screenshot presented to a user who has won the bidding process. The user is notified that he has won the bid, and that his account will be charged in the amount of his bid. The user may then be provided with the ability to initiate contact with the outstanding user. For example, the user may be presented with a link 520 to click in order to send an e-mail to the outstanding user. As should be understood, a link to send an e-mail is merely exemplary and any other form of communication is possible. For example, the bid winner may receive an actual e-mail address to use to send an e-mail, a phone number to send a text message or make a phone call, or any other identifier that can be used to make contact with the outstanding user. What should be understood is that access to the outstanding user is controlled by the dating website, and only users who have won the bidding process will be given the information necessary to initiate contact with the outstanding user.

FIG. 5(c) depicts a screen shot of a user who did not win the bidding process. The user may be notified that he did not win, but that there will be a new bidding process the next day. The user may be encouraged to attempt to enter a winning bid the next day. As should be clear, the period of the bidding process is established by the website owner or the outstanding user as described above with reference to FIG. 3.

Although FIG. 5 is described in terms of a user entering a single bid, and then being notified that he has won or lost the bid, embodiments of the invention are not so limited. In some embodiments, the user may be notified that he has been outbid, but that the bidding process for the period is not over. The user may then be allowed to enter a higher bid in an attempt to win the right to initiate contact with the outstanding user. This process advantageously allows the web site owner and/or the outstanding user to increase their revenue. If multiple users all have a strong desire to initiate contact with the outstanding user, this may begin a bidding war which will enhance the revenue received as a result of the bidding process.

FIG. 6(a) depicts a screenshot of discontinuing the bid filtering process. At some point in time, the website owner may determine that the outstanding user is no longer outstanding. At this point, the outstanding user may be demoted 610 to a regular user. For example, as depicted in FIG. 6(a) the total amount of revenue generated 620 by each user designated as outstanding may be displayed. The website owner may select users that are not generating sufficient revenue to demote from outstanding user status.

Although FIG. 6(a) is depicted in terms of total revenue generated, embodiments of the invention are not so limited. For example, any of the criteria described with reference to FIG. 3 may also be used to determine when a user is demoted from outstanding user status. For example, over time, the attractiveness rating of a user may decrease, such that the user is no longer considered outstanding. A similar effect can occur with any of the other categories that are used to select outstanding users.

In one embodiment, the website owner may monitor the number of users who are attempting to bid on the opportunity to contact the outstanding user. If the number of users that are entering bids decreases below a threshold level, the website owner may choose to demote the outstanding user to a normal user, thus disabling the bid filtering process.

FIG. 6(b) depicts a screenshot of discontinuing the bid filtering process initiated by the outstanding user. As described above, the bid filtering process may be advantageously used by outstanding users to decrease the amount of incoming contact requests received. However, at some point, the outstanding user may feel that they are overly limiting themselves by participating in the bid filtering process. The outstanding user may wish to open up the opportunity for contact to all users, not just the high bidders.

In embodiments where revenue is shared between the outstanding user and the website owner, the outstanding user may be shown the amount 630 of money he has earned from the bid filtering process. After reviewing this total, the outstanding user is better able to determine if he truly wishes to turn off the bid filtering process.

It should be understood that the ability to turn off bid filtering may not always be available for the outstanding user. In embodiments where the website owner is generating revenue form the outstanding user, the website owner may not wish to turn off bid filtering. Embodiments of the present invention are flexible with regards to who can initiate the bid filtering process, who can alter the process, and who can terminate the process. However, the website owner is the ultimate authority in the final implementation of the bid filtering process.

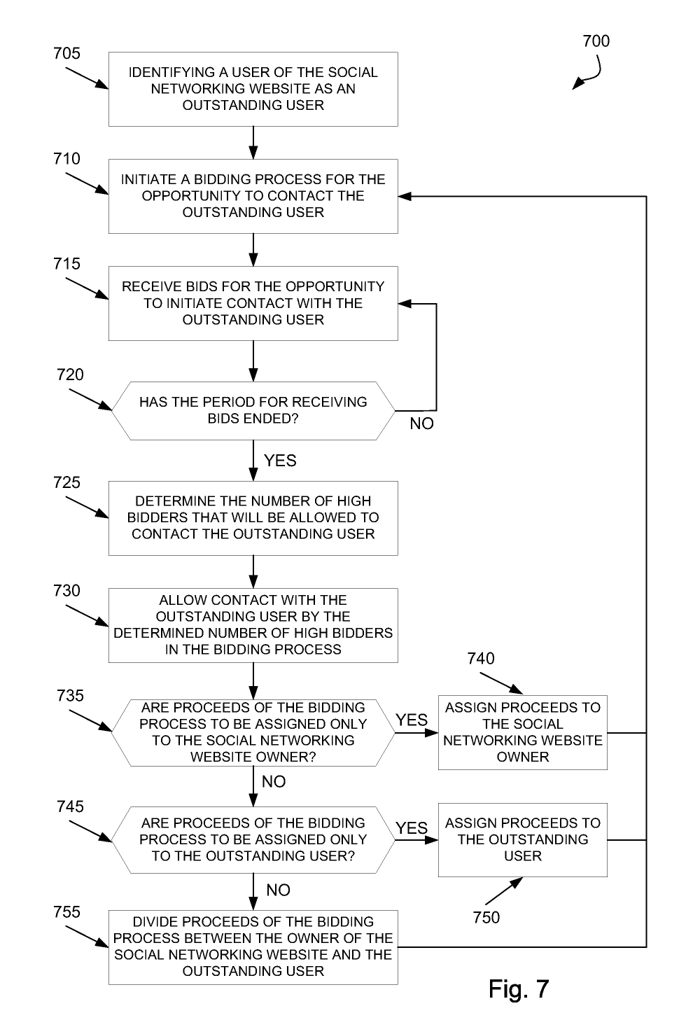

FIG. 7 depicts a high level flow chart of the bid filtering process. The flow chart 700 begins at step 705, wherein a user of a social networking website is identified as an outstanding user. As described above, in some embodiments, this determination is made by the website owner. The website owner may manually or programmatically review the user base of the social networking website and identify users that are to be designated as outstanding.

In some embodiments, users may identify themselves as outstanding users. In some cases, a user may wish to limit the number of incoming contact requests, and this self selection process will aid in that end. Regardless of if the outstanding users are selected by the owner of the website or self selected, once identified, a bidding process can be implemented.

Art step 710, a bidding process is initiated for the opportunity to contact the identified outstanding user. As explained above, other users who wish to contact the outstanding user must engage in the bidding process before being given the opportunity to communicate with the outstanding user.

At step 715, any bids for the opportunity to initiate contact with the outstanding user are collected. At step 720, it is determined if the period for receiving bids has ended. For example, the period could be hourly, daily, or monthly. If the period has not ended, the process returns to step 715, wherein additional bids can be collected.

If the period for receiving bids has ended, the process moves on to step 725, wherein the number of high bidders that will be allowed to contact the outstanding user is determined. As explained above, in some embodiments, only the highest bidder is given the opportunity to initiate contact, while in other embodiments contact may be limited to some defined number of top bidders. In step 725, the number of top bidders that will be given the opportunity to initiate contact with the outstanding user is determined.

The process then moves on to step 730 wherein the determined number of high bidders are allowed to make contact with the outstanding user. In some embodiments, being allowed to make contact comprises granting the right to send an e-mail to the outstanding user. In alternate embodiments, being allowed to make contact can include the ability to send a text message, a phone call, and instant message, or any other suitable communications mechanisms.

In step 735 it is determined if the proceeds of the bidding process are to be assigned only to the owner of the social networking website. If so, the process moves to step 740, wherein the proceeds are assigned to the social networking website owner. If the answer to the question in step 735 is no, the process moves on to step 745 wherein it is determined if the proceeds of the bidding process are to be assigned only to the outstanding user. If so, the process moves to step 750, wherein the proceeds are assigned to the outstanding user.

If the answer to the question in step 745 is no, then the process moves on to step 755, wherein the proceeds are divided between the social networking website owner and the outstanding user. As explained above, the proceeds may be divided between the outstanding user and the website owner in any suitable ratio. The ration of the distribution will typically be decided by the owner of the social networking website.

Regardless of how the proceeds of the bidding process are assigned or divided, the process then moves back to step 710, wherein the bidding process is started again for a new period. This process will continue as long as the outstanding user is designated and outstanding user. For example, the process continues until either the website owner deselects the outstanding user or the outstanding user deselects himself as an outstanding user. Disabling the bid filtering has been described with reference to FIG. 6.

FIG. 8 is a high level block diagram of a computer system that may be used to implement any of the entities or components (e.g., the dating website or the computers used by the users to access the dating website, etc.) described above may include one or more of the subsystems or components shown in FIG. 8, which is a block diagram of a computer apparatus. The subsystems shown in FIG. 8 are interconnected via a system bus 875. Additional subsystems such as a printer 844, keyboard 848, fixed disk 849, monitor 846, which is coupled to display adapter 882, and others are shown. Peripherals and input/output (I/O) devices, which couple to I/O controller 841, can be connected to the computer system by any number of means known in the art, such as serial port 884. For example, serial port 884 or external interface 881 can be used to connect the computer apparatus to a wide area network such as the Internet, a mouse input device, or a scanner. The interconnection via system bus allows the central processor 843 to communicate with each subsystem and to control the execution of instructions from system memory 842 or the fixed disk 849, as well as the exchange of information between subsystems. The system memory 842 and/or the fixed disk 849 may embody a computer readable medium. The computer readable medium may be non-transitory, such as in the form of the fixed disk, and embody thereon a set of instructions which when executed by the computer cause the computer to execute the methods of the invention described above.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

What is claimed is:

1. A method of restricting access to a user of a social networking website comprising:
identifying the user of the social networking website as an outstanding user;
initiating, with a server computer, a bidding process for the opportunity to contact the outstanding user; and
allowing contact with the outstanding user by a high bidder in the bidding process.

2. The method of claim 1, wherein the bidding process is conducted periodically.

3. The method of claim 2, wherein the period is one of hourly, daily, and weekly.

4. The method of claim 1, wherein an owner of the social networking website identifies the outstanding user.

5. The method of claim 1, wherein the user self identifies as the outstanding user.

6. The method of claim 1 wherein the opportunity to contact the outstanding user includes the opportunity to send an e-mail to the outstanding user.

7. The method of claim 1 further comprising allowing contact with the outstanding user by a top five bidder in the bidding process.

8. The method of claim 1, wherein bids in the bidding process comprise monetary value and proceeds of the bidding process are provided to the owner of the social networking website.

9. The method of claim 1, wherein bids in the bidding process comprise monetary value and proceeds of the bidding process are distributed between the owner of the social networking website and the outstanding user.

10. The method of claim 1, wherein bids in the bidding process comprise credits on the social networking website.

11. The method of claim 10 wherein credits are earned based on interactions with the social networking website.

12. The method of claim 1, further comprising:
reviewing all users of the social networking website to identify outstanding users.

13. The method of claim 12, wherein outstanding users are identified based on a number of contact requests.

14. The method of claim 1 wherein once the high bidder is allowed contact with the outstanding user, the high bidder is no longer restricted from contacting the outstanding user.

15. A non-transitory computer readable medium embodying thereon a set of instructions, which when executed by a computer cause the computer to perform the steps of:
identifying the user of the social networking website as an outstanding user;
initiating a bidding process for the opportunity to contact the outstanding user; and
allowing contact with the outstanding user by a high bidder in the bidding process.

16. The non-transitory computer readable medium of claim 15 further comprising:
reviewing all users of the social networking website to identify outstanding users.

17. The non-transitory computer readable medium of claim 15 wherein bids in the bidding process comprise monetary value and proceeds of the bidding process are distributed between the owner of the social networking website and the outstanding user.

18. A system comprising:
a processor; and
a memory coupled to the processor, the memory comprising a set of instructions which when executed by the processor cause the processor to perform the steps of: identifying the user of the social networking website as an outstanding user; initiating a bidding process for the opportunity to contact the outstanding user; and allowing contact with the outstanding user by a high bidder in the bidding process.

19. The system of claim 18 wherein bids in the bidding process comprise credits on the social networking website.

20. The system of claim 18 wherein once the high bidder is allowed contact with the outstanding user, the high bidder is no longer restricted from contacting the outstanding user.
